(19) United States
(12) Patent Application Publication
(10) Pub. No.: US 2003/0149933 A1
(43) Pub. Date: Aug. 7, 2003

(54) Graphical design of chemical discovery processes

(76) Inventors: Marco Falcioni, San Francisco, CA (US); Ray Carhart, Cupertino, CA (US); Al Gushurst, Pleasanton, CA (US); William C. Rust, Sunnyvale, CA (US)

Correspondence Address: FISH & RICHARDSON P.C., 500 ARGUELLO STREET, SUITE 500, REDWOOD CITY, CA, 94063, US

(21) Appl. No.: 10/061,960

(22) Filed: Feb. 1, 2002

(51) Int. Cl. G06F 17/00

(52) U.S. Cl. 715/500

(57) ABSTRACT

Methods and apparatus, including computer program products, implement techniques for generating library designs for sets of experiments. A library array including a plurality of elements represents an arrangement of experiments. A plurality of sources are defined to represent materials or conditions to be used in the experiments. A mapping sequence defines an ordered sequence of maps representing the application of sources to elements of the library array. A library design is generated, representing the library array, the sources, the maps and the mapping sequence. The library design specifies for each of a plurality of library elements amounts of one or more sources to be applied to the corresponding library element. The amounts are defined at least in part by the order of maps in the mapping sequence.

### BACKGROUND

This invention relates to methods and apparatus for designing combinatorial experiments. There is currently a tremendous amount of activity directed toward the discovery and optimization of materials and material systems such as phosphors, polymers, pharmacological compounds, semiconducting solids, and devices and the like. These new materials are typically useful because they have superior values for one or several properties. These properties could include (but are not limited to) electrical conductivity, color, bio-inertness, fabrication cost, or any other property. A variety of fields (pharmacology, chemistry, materials science) focus on the development of new materials and devices with superior properties. Unfortunately, even though the chemistry of both small molecules and extended solids has been extensively explored, few general principles have emerged that allow one to predict with certainty the composition, structure, and reaction pathways for synthesis of such materials. New materials are typically discovered through experimentation, rather than designed from existing principles.

The ability to discover new materials presupposes (1) the ability to actually make the material, and (2) the ability to accurately measure the properties of interest, or other properties that correlate with the properties of interest. Development of a material with superior properties also requires (3) the ability to make materials that are different in some way—meaning that the materials are in some sense not identical, whether in composition, molecular structure, processing history, raw material source, or any other difference that might impact a material's properties—and (4) a way to compare the properties of the different materials.

A common challenge is understanding how two materials actually differ from each other. Any two materials might be similar in one or many ways (e.g., composition) but different in many other ways. Thus, the properties of one material might be “better” (for a particular purpose) than those of another material for any number of reasons. One goal of experimental science is determining how properties vary with different parameters. In this sense, a parameter is any variable whose value can change in either a continuous or discontinuous fashion. Parameters can include concentrations of different chemical species (e.g., elements, compounds, solvents), temperature, annealing time, molecular weight, exposure time to radiation, process sequence or any other variable. Experimental studies typically examine the variation of a given property (e.g., smell) with a measured parameter (e.g., molecular weight), often with the implicit assumption that all other parameters are held constant (i.e., their values are identical for the compared samples). In the ideal case, two materials only differ in one parameter, and variation in the measured property is construed to be caused by variation in this parameter.

Unfortunately, it is difficult or impossible to completely determine how two materials are “different”. While variation in a given parameter (e.g., chemical composition) might be fairly obvious (e.g., one sample has 20% more nitrogen than the other), variation in another parameter might remain hidden (e.g., one sample has a slightly preferred grain orientation, vs. another sample's random orientation). The challenge is determining which parameters have a significant effect on the property of interest. This challenge requires the examination of the effects of many different parameters on the desired properties. Variation in each of these parameters creates a parameter space: a high-dimensional space defined by all the relevant parameters that describe a material. A single material is thus defined by its coordinates within this parameter space—the values for each of these parameters for the given material. The goal of materials development is finding the coordinates of the material with the best set of desired properties. The commonly used analogy “looking for a needle in a haystack” can loosely describe this process: the parameter space is the “haystack”, and the material(s) with the best set of properties is (are) the needle(s).

Traditionally, the discovery and development of various materials has predominantly been a trial and error process carried out by scientists who generate data one experiment at a time—in other words, each axis in the parameter space is examined serially. This process suffers from low success rates, long time lines, and high costs, particularly as the desired materials increase in complexity. Nevertheless, these methods have been successful for developing materials whose properties are governed by a relatively small number of parameters.

However, many properties can be a function of a large number of different parameters. Additionally, the combined effects of parameter variation can be much more complicated than the discrete effects of varying one or two parameters by themselves. For such a property, a very large parameter space must be examined in order to find the material with the best properties. As a result, the discovery of new materials often depends largely on the ability to synthesize and analyze large numbers of new materials over a very broad parameter space. For example, one commentator has noted that to search the system of organic compounds of up to thirty atoms drawn from just five elements—C, O, N, S and H—would require preparing a library of roughly 10⁶³ samples (an amount that, at just 1 mg each, is estimated to require a total mass of approximately 10⁶⁰ grams—roughly the mass of 10²⁷ suns). See W. F. Maier, “Combinatorial Chemistry—Challenge and Chance for the Development of New Catalysts and Materials,” Angew. Chem. Int. Ed., 1999,38, 1216. When material characteristics vary as a function of process conditions as well as composition, the search becomes correspondingly more complex. One approach to the preparation and analysis of such large numbers of compounds has been the application of combinatorial methods.

In general, combinatorics refers to the process of creating vast numbers of discrete, diverse samples by varying a set of parameters in all possible combinations. Since its introduction into the bio- and pharmaceutical industries in the late 80's, it has dramatically sped up the drug discovery process and is now becoming a standard practice in those industries. See, e.g., Chem. Eng. News, Feb. 12, 1996. Only recently have combinatorial techniques been successfully applied to the preparation of materials outside of these fields. See, e.g., E. Danielson et al., SCIENCE 279, pp. 837-839, 1998; E. Danielson et al., NATURE 389, pp. 944-948, 1997; G. Briceno et al., SCIENCE 270, pp. 273-275, 1995; X. D. Xiang et al., SCIENCE 268, 1738-1 740, 1995. By using various rapid deposition techniques, array-addressing strategies, and processing conditions, it is now possible to generate hundreds to thousands of diverse materials on a substrate of only a few square inches. These materials include, e.g., high Tc superconductors, magnetoresistors, and phosphors. Using these techniques, it is now possible to create large libraries of chemically diverse compounds or materials, including biomaterials, organics, inorganics, intermetallics, metal alloys, and ceramics, using a variety of sputtering, ablation, evaporation, and liquid dispensing systems as disclosed, for example, in U.S. Pat. Nos. 5,959,297, 6,004,617, 6,030,917 and 6,045,671, and U.S. application Ser. No. 09/119,187, filed on Jul. 20, 1998, each of which is incorporated by reference herein.

An implicit goal of any experimental study is getting the most information for the minimum cost (including time); this goal is especially stringent for large parameter spaces that require vast numbers of experiments. This requires (1) maximizing the information content of each experimental point, and (2) minimizing the resource cost to synthesize and measure each experimental point. The process of deciding where in the parameter space to make and measure samples is called “sampling” or “populating” the parameter space.

Scientists typically undertake this process by designing libraries or arrays containing multiple combinations of starting chemicals and process conditions. Computer programs have been used for life science libraries, and some software applications have been applied to materials. Many of these programs allow for step-by-step input of a detailed protocol for synthesizing a library of materials, but do not allow for definition of chemical ratios or process parameters. To implement such protocols, the user must manually determine the proper concentration and quantity of each starting material to achieve a desired ratio of starting materials in each library member. For large libraries with shared starting solutions, this becomes unwieldy to solve manually without significantly limiting the diversity studied within one library. Other programs allow for definition of chemical ratios or process parameters to apply to a whole library, by do not provide for high level definition of multi-dimensional variation of these ratios or parameters across the spatial dimensions of the library, also limiting the diversity that may be studied within a single library. Still other programs, such as Library Studio™, available from Symyx Technologies, Inc., of Santa Clara, Calif., provide for the definition of chemical ratios and for the treatment of process parameters in the library design, process, but do not provide for the incorporation of more complex notions such as process sequence and equivalence in library design. Accordingly, there remains a need for methods and computer programs to expand scientists' ability to design complex materials libraries for combinatorial experiments.

### SUMMARY

The invention provides methods and apparatus for generating library designs for experiments. In general, in one aspect, the invention features computer-implemented methods and apparatus, including computer program products, implementing techniques for generating a library design for a set of experiments. The techniques include defining a library array including a plurality of elements and representing an arrangement of experiments in the set of experiments; defining a plurality of sources; receiving user input defining a mapping sequence including a plurality of maps representing the application of sources to elements of the library array; and generating a library design including electronic data representing the library array, the sources, the maps and the mapping sequence. The library elements represent potential locations for experiments in the set of experiments. The sources include electronic data representing a material or condition that can be used in the set of experiments. The maps include electronic data identifying one or more library elements and defining an amount of a corresponding source to be applied to the identified library elements. The maps are ordered to define the mapping sequence. The library design specifies for each of a plurality of library elements amounts of one or more sources to be applied to the corresponding library element. The amounts are defined at least in part by the order of maps in the mapping sequence.

Particular implementations can include one or more of the following features. The techniques can include displaying a visual representation of a plurality of experiments in the set of experiments. The visual representation can include a representation of at least a portion of composition including the specified amounts for a plurality of library elements corresponding to the plurality of experiments. The visual representation can include a representation of the mapping sequence, such that the maps in the mapping sequence are selectable in the visual representation. The visual representation can include a representation of a portion of a composition including the specified amounts for a plurality of library elements, such that the portion can be determined based on a set of maps selected by the user. One or more of the maps in the mapping sequence can have an associated equation defining a mathematical relationship for determining the amount of the corresponding source to be applied to the identified library elements based on an amount defined by a prior map in the mapping sequence. The mapping sequence can include a first group of maps having a first set of associated equations defining a plurality of mathematical relationships for determining the amount of one or more sources to be applied to one or more identified library elements, such that the first set of associated equations is solvable as a set of simultaneous equations. The mapping sequence can include a second group of maps having a second set of associated equations defining a plurality of mathematical relationships for determining the amount of one or more sources to be applied to one or more identified library elements, such that the first and second sets of associated equations are separately solvable as sets of simultaneous equations. The plurality of maps can include a remove map defining an amount of a source to be removed from the identified library elements. One or more of the sources can have type information representing a role played by the source in a chemical reaction and equivalence information quantifying behavior relating to the role. One or more of the maps can define amounts for the one or more sources based in part on equivalence information.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram illustrating a system for graphically designing sets of combinatorial experiments.

FIG. 2 is a flow diagram illustrating a method for generating a library design for a set of experiments.

FIG. 3 illustrates a user interface for displaying a visual representation of a library design.

FIGS. 4A-4D illustrate a user interface for defining a map for specifying amounts of a source to be applied to elements in a library array.

FIG. 5 illustrates a schematic design for a set of copolymerization experiments involving three monomers.

FIGS. 6A-B illustrate user interfaces displaying a set of chemical sources and a library array, respectively.

FIG. 7A illustrates a user interface displaying a set of selected library elements in a library array.

FIG. 7B illustrates a user interface for defining a gradient map.

FIG. 7C illustrates a user interface displaying the result of a mapping to a set of selected library elements.

FIG. 8A illustrates a user interface for defining a map.

FIG. 8B illustrates a user interface displaying the results of applying multiple maps to a set of selected library elements.

FIGS. 9A-B illustrate a user interface displaying amounts of multiple sources applied to elements of a library array, and a mapping sequence defining those amounts, respectively.

Like reference symbols in the various drawings indicate like elements.

### DETAILED DESCRIPTION

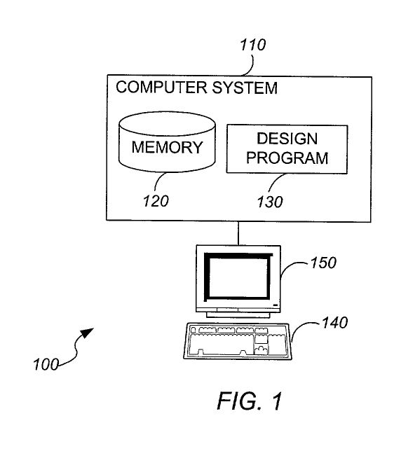

The invention relates to methods and apparatus for graphically designing a set of experiments. FIG. 1 illustrates an experiment design system 100 that includes a general-purpose programmable digital computer system 110 of conventional construction, including a memory 120 and a processor for running a design program 130. Design system 100 also includes input devices 140, such as a keyboard or mouse, output devices 150, such as a conventional display monitor, and, optionally, conventional communications hardware and software by which computer system 110 can be connected to other computer systems, such as a computer system controlling one or more materials handling apparatus (e.g., a synthesis robot, vapor deposition equipment or the like). In some implementations, design program 130 implements a graphical user interface that is displayed to a user over a display device such as a monitor. Optionally, system 100 can be implemented as part of a process control and data management system, such as is described in WO 01/79949, which is incorporated by reference herein. Although FIG. 1 illustrates design system 100 as being implemented on a single computer system, the functions of system 100 can be distributed across multiple computer systems, such as on a network. A typical user of system 100 is a research chemist or materials scientist.

As used in this specification, experiments are performed on libraries of materials. A library of materials is an arrangement—e.g., a matrix or array—of two or more members, or library elements, generally containing some variance in chemical or material composition, amount, reaction conditions, and/or processing conditions. A single library element, in turn, represents a single constituent, location, or position in a library containing one set of chemicals or materials subject to one set of reaction or processing conditions. The particular materials, compounds or chemistries involved are not critical; instead, the methods, computer programs and systems described are broadly applicable to a wide variety of library types and chemistries. Thus, in particular implementations, libraries used in system 100 can include, for example, libraries of biomaterials, organics, organometallics, inorganics, intermetallics, metal alloys, or ceramics, and in particular heterogeneous and homogeneous catalysts, specialty application polymers and formulations of organic and inorganic materials including, for example mixtures of polymers and/or bioactive materials with any other materials. Such libraries can be employed in experiments directed to the discovery of new and useful compositions, such as superconductors, zeolites, magnetic materials, phosphors, catalysts, thermoelectric materials, high and low dielectric materials, and other materials of interest. Experiments on such libraries can involve the measurement of a variety of properties, including without limitation electrical, thermal, mechanical, morphological, optical, magnetic, chemical, conductivity, super-conductivity, resistivity, thermal conductivity, anisotropy, hardness, crystallinity, optical transparency, magnetoresistance, permeability, frequency doubling, photoemission, coercivity, dielectric strength, or other useful properties that will be apparent to those of skill in the art, and can yield data in the form of, and can generate data in the form of, for example, electrical voltages and resistivity, photon counts, and frequency and wavelength of electromagnetic radiation, any of which could be measured on a time-varying basis or as a combination of each other in the form of dependent-independent variables.

Libraries can include physical arrays of materials, with different materials located at different regions of a substrate. In one implementation, each library includes one or more library elements, each of which may be represented as a region in an arrangement (e.g., an array) of one or more regions. A library can include two or more library elements, preferably four, ten, twenty, or even ninety-six or more library elements. The library elements may, but need not necessarily, correspond to locations on a physical substrate (such as a microtiter plate, wafer or the like) on which the library was or will be created. However, while the library may correspond to the geometry of the ultimate physical substrate, it may also represent a collection of library elements on a more conceptual level. Conventionally, libraries may be depicted as square or rectangular arrays. However, libraries can be represented or prepared in any convenient shape, such as square, rectangle, circle, triangle or the like, and in one, two or three dimensions, depending, for example, on the underlying chemistry or apparatus involved. Details of library design and preparation are further discussed in WO 00/23921 and WO 00/67086, and in U.S. Pat. No. 5,776,359, U.S. Pat. No. 5,959,297, U.S. Pat. No. 5,985,356, U.S. Pat. No. 6,030,917, U.S. Pat. No. 6,034,775, and U.S. Pat. No. 6,149,882, each of which is incorporated by reference herein.

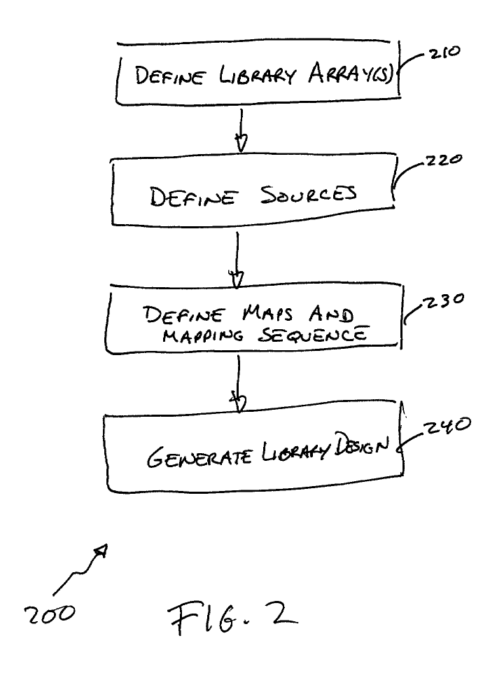

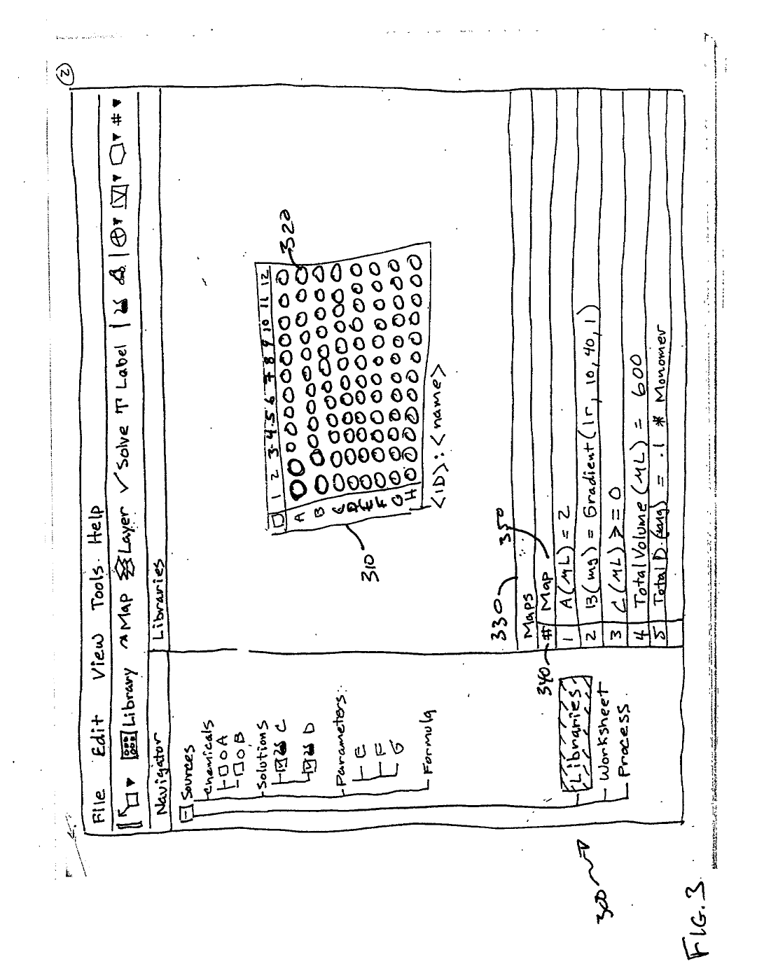

FIG. 2 illustrates a general method 200 of generating a library design for a set of experiments. Design program 130 first defines one or more library arrays (step 210) and one or more sources (step 220). As used in this specification, library array is a conceptual arrangement of cells or library elements that represent individual experiments in a set of experiments, and that may be considered to correspond (either directly or indirectly) to locations in a combinatorial library at which experiments will be performed. In one embodiment, a library array may represent a physical substrate in or on which a library is created (i.e., in or on which the set of experiments will be performed). In other embodiments, however, a library array is not constrained to represent an actual physical substrate, but can correspond to a conceptual library environment. In a preferred embodiment, a library is represented in system 100 as a library object representing a collection of library element objects arranged in some predetermined way. Library element objects represent a “vial” or a “cell”, and can contain a set of amounts and a set of parameter values. Optionally, library element objects can have additional functionality allowing for the removal of source amounts either through evaporation type steps or through subsequent mapping, as in formulation type operations. In one implementation, the library array is represented as a two dimensional matrix 310 of locations 320 in a user interface 300, as illustrated in FIG. 3. Individual elements of the library array are represented as matrix elements 320. The contents of a library element (e.g., a representation of the materials and conditions that comprise an experiment assigned to the location represented by the library element) can be visually represented in this interface as will be discussed in more detail below. Using conventional graphical selection techniques (e.g., using a mouse to select one or more locations in matrix 310, or clicking and dragging to select multiple locations at once), the user can select one or more library elements for further manipulation or processing, such as to apply a map to the selected library elements, to display the composition of those elements, or the like, as will be discussed below.

A source is a chemical entity (e.g., a particular chemical element, compound or mixture of chemicals) or a condition (e.g., an external process condition such as pressure, temperature, time, flow rate, voltage, current, stirring speed or the like) that can be applied to elements of a library array. In a preferred implementation, each source is represented in system 100 as a source object having a name that is unique within a given library design. Each source can have a Type property (or properties) defining the role the source will play in the library design—for example, identifying the source as a process condition (temperature, pressure, and the like), or, for chemical entities, as an initiator, activator, etc. Types generally perform two separate functions—first, to provide an alias for the source, and second, to express a numerical relationship between a source and one of its properties. In the first case, types provide a mechanism to group sources together by placing them in classes: Monomer, Activator, P-Block, etc. In this case, the Type is another name that the source should be aware of; when a source is queried for one of its aliases, it should behave as if it were queried for itself.

In the second case, types provide a mechanism to build a numerical relationship (equivalence) that expresses a structural or chemical feature of the source. For example, H₂SO₄ has a molar equivalence of two when used as an acid. The type property can be used, in combination with an equivalence property (having a value of two in this example), to express this relationship, such that for any query involving sulfuric acid specifying a type “Acid” and units of Mole, a factor of 2.0 is used, signifying that the source provides two moles of H⁺ per mole of sulfuric acid. Similarly, the type property can be used to define the amount of a chemical entity that is included in (and provided by) a source. Thus, for example, a type “Cu source” can be used to signify the amount of copper supplied by a given source or sources—specifying, for example, that “each ml of source A contains 5 umoles of Cu.” Mathematical relationships can then be specified to define the total amount of the respective chemical entity for one or more library elements (e.g., “the total Cu from all sources for library element 12 should be 25 umoles”) as will be described in more detail below. Equivalence can be expressed in a variety of units, such as mol/ml, mol/mg, mg/mol, mg/ml, ml/mg, mg/mg and ml/ml.

Sources that comprise chemical entities have additional properties identifying the chemical species (e.g., the atomic element, molecular compound, mixture or composition), including, e.g., properties defining density, molecular weight, chemical structure, type and equivalences, as discussed above. Optionally, these species-specific properties can be implemented as properties of chemical objects that are defined for each chemical entity that can be used in the library design (whether individually or as a component in a mixture of chemical entities. A source that contains a mixture of chemical entities can be represented, e.g., as a collection of components describing mole or mass percent solutions. The density of a mixture can be determined according to a number of different density models, including known density, in which the density is a specified read/write property, ideal mixing, in which the density is calculated from the components assuming ideal mixing behavior, or non-ideal mixing, in which density is calculated from the components and is corrected by a “DensityCorrection” parameter, expressed in percent. Positive values describe solutions that are denser that ideal, and the opposite for negative values.

The user defines each library array and source that will be used in the set of experiments by creating new libraries or sources through a input devices 140 or by selecting desired pre-defined libraries or sources from memory 120. In some implementations, design program 130 can be configured to interface with commercially available chemical inventory systems to retrieve information regarding chemical entities that are available for use in the set of experiments. In a preferred implementation, libraries and sources are defined by user input—for example, based on inputs specifying the relevant properties of library arrays (e.g., library dimensions) and sources (e.g., source type, units, chemical properties), or on inputs selecting pre-defined library arrays and/or sources from memory. Optionally, one or more library arrays and/or sources can be provided by system 100—for example, as a default. Library arrays and sources can be defined by the user through a collection of graphical interfaces providing for the entry of values defining the relevant properties, such as library dimensions and source properties as discussed above. One such collection of interfaces is described in WO 00/23921.

Once the relevant library arrays and sources have been defined, design program 130 defines a set of maps that describe how the sources are to be applied to the elements of the library array or arrays (step 230). Maps can be defined to apply a single source to a single element of a library array, one source to multiple library array elements or multiple sources to multiple library array elements (e.g., mapping materials located at a set of locations in a parent library to elements of a library array representing a daughter library). As used in this specification, “apply” and “application” include depositing or dispensing an amount or amounts of a source (or a chemical component of a source) at or removing an amount or amounts of a source (or a chemical component of a source) from one or more library elements, such that in some implementations maps can define the removal of a chemical from a set of elements—for example, evaporation or filtration to remove solvent, filtration of precipitate, and the like. In a preferred implementation, the maps are ordered to define a mapping sequence, which can take the form, e.g., of an ordered list of maps. In some implementations, map order can be expressly defined by the user (e.g., as a property of each individual map); alternatively, it can be defined based on, e.g., the order in which the maps are defined in design program 130.

Thus, in general a map defines the application of one or more sources to a set of library elements. In one implementation, a typical map identifies a source to be applied, a set of one or more amounts of the source (or a chemical entity that is a component of the source) to be applied (in a given unit appropriate to the nature of the source), and a set or “footprint” of library elements to which those amounts will be applied. A mapping of multiple sources can be implemented as a collection of such maps that collectively describe mapping from elements of one library array to elements of another library array.

Maps can be defined to specify a uniform application of a source to a set of library elements, such that the same amount of the source is applied to each library element identified in the map footprint. Alternatively, a map can be defined to specify discrete amounts of the source that will be applied to particular library elements, based, for example, on a spreadsheet provided by the user. Maps can also define source amounts to be applied to the selected library elements based on associated mathematical relationships that specify individual source amounts (including amounts of one or more chemical entities that are components of sources) as a function of other values. In some implementations, maps can define source amounts as a function of values defined by previous maps in the mapping sequence. That is, a given map can take as inputs one or more source amounts defined by previous maps, and define source amounts as a function of those inputs.

Mathematical relationships can include, for example, mathematical gradients defining the amount of a source to be applied to selected library elements based on the location of the library element in the library array. A simple gradient is defined by a minimum value, representing the minimum amount of the source to be applied, and a maximum value, representing the maximum amount of the source to be applied, and a step size to be applied between the minimum and maximum values. Any type of mathematical gradient can be used, such as linear, exponential and logarithmic gradients; gradientscan be applied in any orientation relative to the geometry of the library array. Optionally, non-linear gradients can include a shape parameter that further defines the transition between specified minimum and maximum amounts. In preferred embodiments, gradients can be applied to any selection, such that the footprint of a gradient map can include non-contiguous library elements. Design program 130 can apply such a gradient by, e.g., finding a maximum bounding shape (e.g., rectangle) surrounding the selected library elements, calculating the gradient values as if the map extended across whole shape, and applying the calculated gradient only to the selected, non-contiguous library elements identified as being in the footprint.

Design program 130 can also support more complex mathematical mapping relationships that define amounts of sources (or their chemical constituents or types) to each other, defined by a set of one or more mathematical expressions (which may be referred to as equations or formulas) associated with maps in the mapping sequence. Each equation is a mathematical expression to be applied over a specified footprint or footprints of library elements. Equations can relate amounts of sources (or chemicals or types) to each other or to other quantities, as illustrated by the exemplary equations set out in Table 1, below.

TABLE 1

| Equation | Description |
|---|---|
| “ethyl alcohol” = 5; (μl) | Sets the total amount of ethyl alcohol to 5 μl |
| | in the selected cells. |
| “ethyl alcohol” + “1-octene”= 500; (μl) | Sets the total amount of both ethyl alcohol |
| | and 1-octene to 500 μl in the selected cells. |
| “catalyst” = 0.05 * “monomer + | Sets the total amount of catalyst to a value |
| 0.10 * “activator” | that is 50% of the monomer plus 10% of the |
| | activator. |
| “ethyl alcohol” = Row( ); (μl) | Sets the total amount of ethyl alcohol to the |
| | μl volume of the row. E.g.: 1 μl in Row 1, 2 |
| | μl in Row 2, and 3 μl in Row 3. |
| “ethyl alcohol” = Col( ); (μl) | Sets the total amount of ethyl alcohol to the |
| | μl volume of the column. E.g.: 1 μl in |
| | Column 1, 2 μl in Column 2, and 3 μl in |
| | Column 3. |
| “ethyl alcohol” = Pos( ); (μl) | Sets the total amount of ethyl alcohol to the |
| | μl volume of the cell position (defined, e.g., |
| | in row-major fashion in which the cells are |
| | counted on a row-by-row basis). |
| TotalVolume = 500; (μl) | Sets the total volume to 500 μl. |
| “monomer” = 0.30 * TotalMass; (mg) | Sets the sum of all monomers to 30% of the |
| | total mass in mg. |
| “initiator” = 0.005 * “monomer”; (mg) | Sets the sum of all initiators to 5% of the |
| | total amount of monomer in mg. |
| “redox” = “initiator”; (mol) | Sets the sum of all redox agents to the exact |
| | mol value of the sum of all initiators. |
| “styrene” = LinG (lr, 0, 200, 1); (μl) | Sets the total amount of styrene to a linear |
| | gradient (LinG) that increases from left to |
| | right (lr) at 0 to 200 μl (0, 200; μl), with a |
| | gradient step of 1 (1 row or column) column |
| | per gradient change. |
| “styrene” = LinG (lr, 0, 200, 1) + | Sets the total amount of styrene to the sum |
| Prev(“styrene”); (μl) | of a linear gradient (LinG) that increases |
| | from left to right (lr) at 0 to 200 μl (0, 200; |
| | μl), with a gradient step of 1 column per |
| | gradient change, plus any previous amounts |
| | of styrene set in any prior map in the |
| | mapping sequence. |
| “styrene” = ExpG (bt, 0, 200, 1, 2.5); (μl) | Sets the total amount of styrene to an |
| | exponential gradient (ExpG) of shape 2.5, |
| | which increases from bottom to top (bt) at 0 |
| | to 200 μl (0, 200; μl), with a gradient step of |
| | 1 row per gradient change. |
| “styrene” = LogG (tb, 0, 200, 2, −2.5); (μl) | Sets the total amount of styrene to a |
| | logarithmic gradient (LogG) of shape −2.5, |
| | which increases from top to bottom (tb) at 0 |
| | to 200 μl (0, 200; μl), with a gradient step of |
| | 1 row per gradient change. |

Design program 130 solves each equation to calculate the amount of a source or chemical (or a source or chemical type) to be applied at each of the specified library elements. Where a mapping sequence includes multiple equations, design program 130 can solve the equations as a set of simultaneous equations, as described in WO 00/23921.

Maps in the mapping sequence can be grouped to form one or more layers. Thus, for example, in implementations where the mapping sequence is represented as an ordered list of maps, groups or layers can be denoted by erecting barriers or delimiters between maps in the list, the barriers identifying sets of maps as a layer. Each layer can contain an ordered set of maps that are subject to special treatment by design program 130. As with maps in general, the maps within a layer can operate on values defined by previous maps, or previous layers, as inputs. Design program 130 can be configured to calculate the effects of maps within a layer as a group, such that a set of equations associated with the maps in a layer will be solved as a set of simultaneous equations, separate from any other mathematical relationships associated the maps outside of the layer.

Maps can be defined by user input—for example, based on inputs specifying the relevant properties of the maps, such as source, amounts, footprint and order in the mapping sequence. Users can also select pre-defined maps from memory. Optionally, one or more maps can also be provided by system 100—for example, as a default.

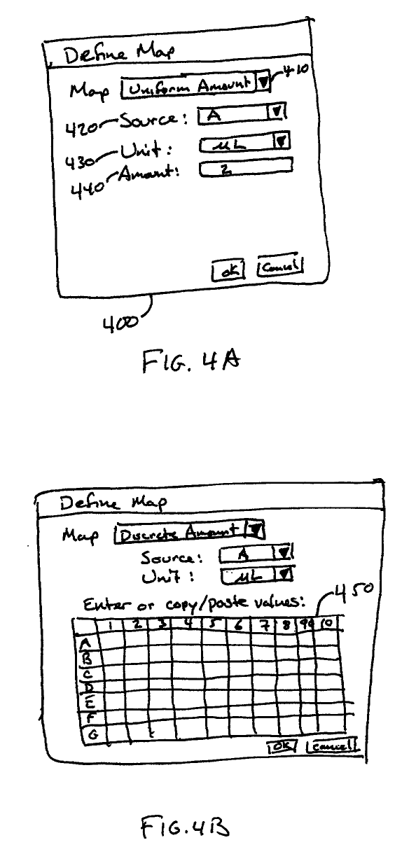

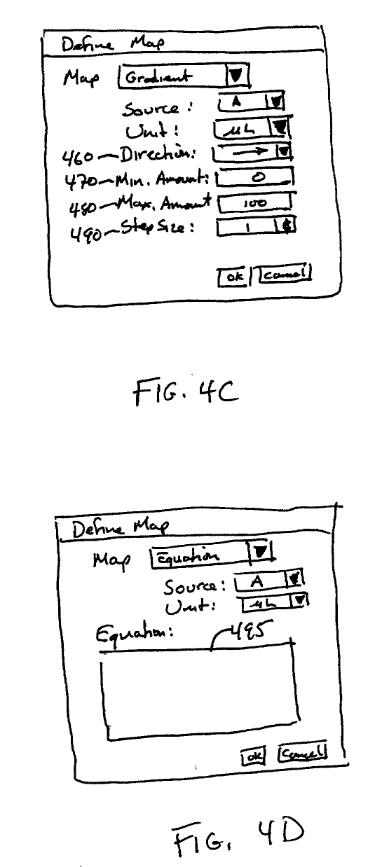

Thus, in one implementation a user can define a map by accessing a Define Map dialog 400 as illustrated in FIGS. 4A-3D—for example, by selecting a set of library elements in a graphical display, right clicking on the selected elements and selecting a Define Map entry from a context sensitive pop-up menu. In drop down list 410, the user selects a Map type, such as Uniform, Discrete, Gradient, or Remove Chemical as discussed above. The user selects a defined source in drop down list 420, and specifies units in drop down list 430. Depending on the selected Map type, the user then specifies any additional information as required, including, for example, an amount in an Amount field 440, representing a single amount to be applied to the library elements in the map footprint for a Uniform map, a spreadsheet of amounts 450 for a Discrete map, and a direction, minimum amount, maximum amount and step size and/or shape (e.g., in fields 460, 470, 480 and 490) for a Gradient map.

The user can define a formula or equation, or set of formulae or equations, by defining one or more “Exists” maps that specify a footprint or footprints for one or more sources to be applied and defining appropriate equations in an Equation dialog 495. The user can define Exists maps by making an appropriate selection in a Define Map dialog, and selecting the desired library elements using, e.g., conventional selection techniques. The user can then define relevant equation properties in an appropriate dialog such as is described in WO 00/23921, and associate the maps and equations as a group or layer

In the implementation illustrated in FIG. 3, the mapping sequence can be represented as a list of maps 330, in which the map order is shown as an entry in column 340, and the map type (and other properties) are shown in Map column 350. The user can select a map or group of maps (e.g., by locating the cursor on a row representing a desired map, and clicking a mouse button) for further processing—for example, to delete a map or move a map in the mapping sequence (i.e., to change the map's order). Optionally, in response to user input selecting a map, design program 130 can be configured to display a Define Map dialog for the selected map, as discussed above, to allow the user to edit the map properties.

Based on the library arrays, sources and maps, design program 130 generates a library design that includes information representing the library array or arrays, the sources, the mappings and the mapping sequence (step 240). In a preferred implementation, the library design is implemented as a Design Object having one or more associated library objects, a collection of source objects, and a collection of mapping objects. Each library object, in turn, is associated with a collection of library element objects representing the elements of the library array. Preferably, the library array, library elements, sources and maps (and other object properties) are accessible to design program 130 and other software applications, such as the automated experiment management system implementing synthesis and data handling methods described in WO 00/67086 and/or WO 01/79949, and can be operated on by methods of the Design Object. For example, each library element can be queried for a Composition, which includes aggregate source amounts (including amounts of any chemical entities that are components of sources—i.e., source mixtures) for the library element defined by the maps applied to the library element. In some implementations, library element composition information can be persisted as a property of the library element. Alternatively, the persisted library design may not explicitly include compositions for its constituent library elements, which may nevertheless be accessible through methods of the library elements (e.g., by calculation of the aggregate effect of maps on the library element).

In some implementations, design program 130 can use the library design to create a set of material handling instructions, which may take the form of a data file or “recipe file”, as described in WO 00/23921. These instructions can be provided as input to an automated experiment management system implementing synthesis and data handling methods such as those described in WO 00/67086 and/or WO 01/79949. Optionally, the library design and/or materials handling instructions can be persisted in a laboratory data management system as described in U.S. application Ser. No. 09/755,623, filed on Jan. 5, 2001, which is incorporated by reference herein.

When the library design is complete (or, optionally, at any time during the design process), design program 130 can display a visual representation of the library design on monitor 150, such as the matrix representation illustrated in FIG. 3. As discussed above, in this implementation the library array or arrays are represented as two-dimensional matrices of locations representing elements of the library array. The composition of each library element (or, optionally, a selected subset of library elements) can be displayed—for example, by representing the fractional amount of sources or chemical entities assigned to library elements as an appropriately sized slice in a pie chart, or by displaying the amount of one or more sources applied to library elements. Optionally, the user can choose to view composition information for only a subset of the sources or chemical entities applied to a given library element or elements, or for only a subset of the mappings in the mapping sequence (e.g., by selecting and “hiding” one or more maps, such that design program 130 removes composition information specified by the hidden map(s) from the displayed representation of the library design).

Design program 130 can be configured to interact with a database (such as a laboratory data management system as described in U.S. application Ser. No. 09/755,623, filed on Jan. 5, 2001, as discussed above) associated with system 100 that is capable of archiving information pertaining to available chemicals, stock materials, composition data for existing library designs and the like. The user can search the database for chemicals based on relevant identifying information, such as chemical name, formula, identification number (e.g., CAS number) or the like, and design program 130 can download chemical attribute information for selected chemicals for use in the current library design. To facilitate archiving and tracking of existing library designs, the user may register one or more libraries on a designed destination in a database associated with system 100. Design program 130 assigns each library so registered an identification number with which each library may later be retrieved from the database. Similarly, the user can load composition data for one or more libraries to the database for later retrieval.

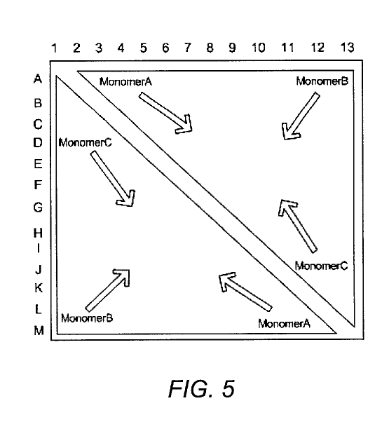

FIGS. 5-9B illustrate a sample design session to create a library design for a set of copolymerization reactions that contain varying amounts of solvent, a single initiator, and varying amounts of 3 different monomers using a preferred implementation of design program 130. A schematic illustration of the desired experiment design is illustrated in FIG. 5.

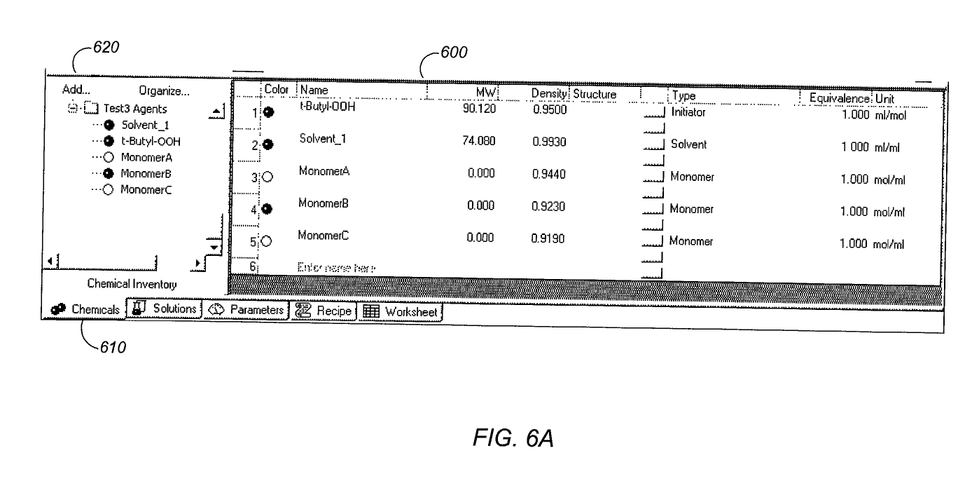

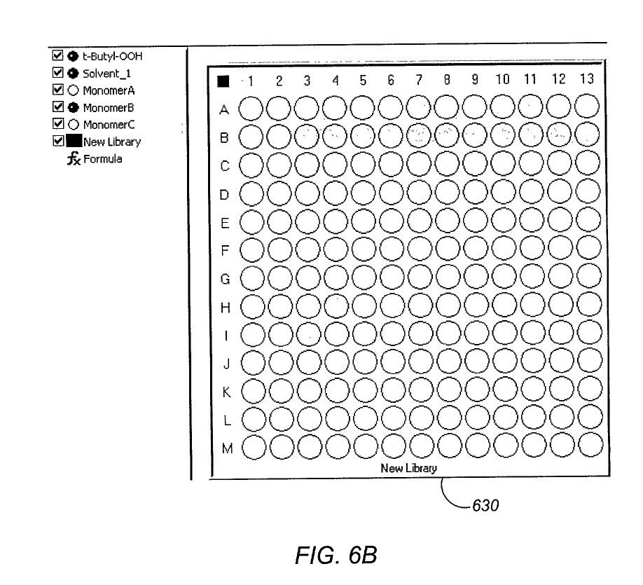

After starting design program 130, the user first assembles the set of sources to be used in the design—here, five chemicals including solvent (Solvent_{—}1), initiator (t-Butyl-OOH), and monomers A, B and C. As illustrated in FIG. 6A, chemicals can be defined by entering appropriate data into the fields of a Chemicals view 600 (accessed by selecting Chemicals tab 610). Alternatively, sources can be selected from available (pre-defined) sources listed in Favorites pane 620.

Next, the user creates a new library. To do so, the user makes an appropriate selection (e.g., selecting a “New Library” button or entry in an appropriate toolbar or menu). Design program 130 prompts the user to name the library—here, “New Library”—and identify a library type—here a rectangular array. After prompting the user to specify the number of rows and columns (here 13 each), design program 130 generates and displays an empty representation 630 of the new library as illustrated in FIG. 6B, with an empty circle representing each library element.

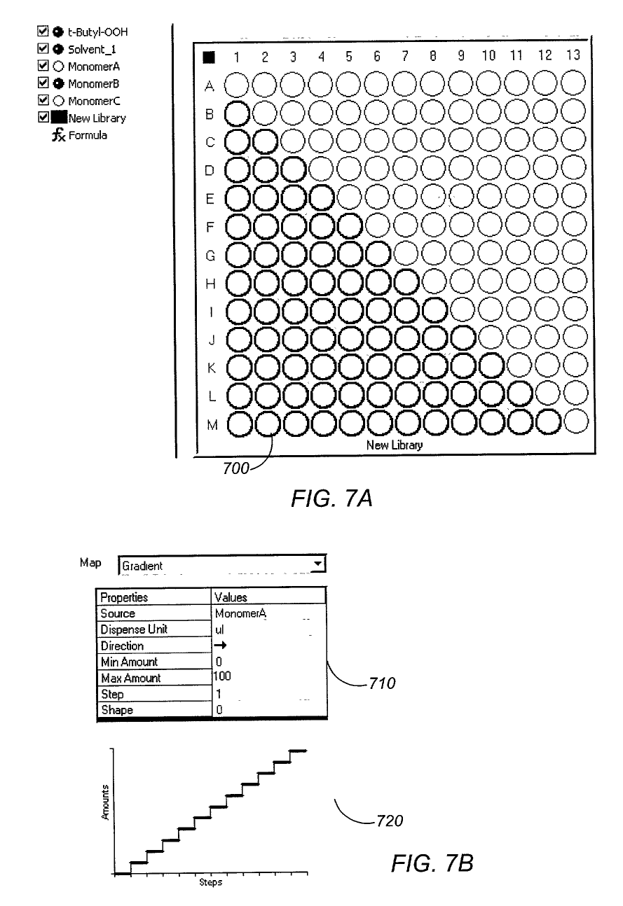

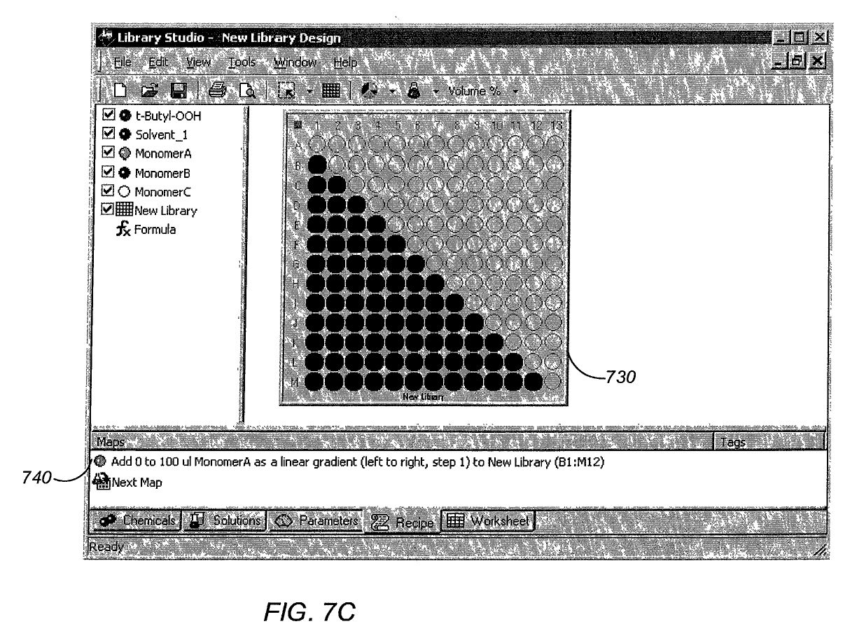

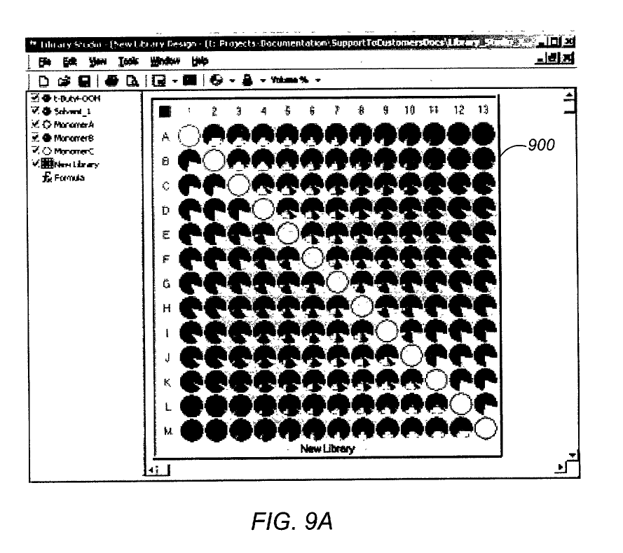

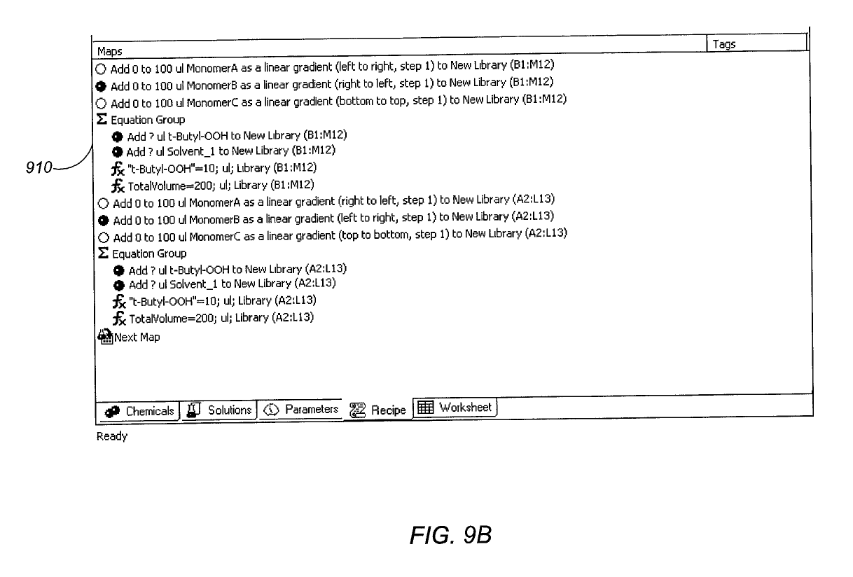

After defining the sources and the library array, the user defines maps assigning the sources to library elements. To assign a gradient of a first monomer to a portion of the library elements, the user selects the desired source (MonomerA) from the source pane and the desired elements B1 to M12 (e.g., using conventional selection techniques such as “click and drag”), causing design program 130 to highlight the selected library elements 700 in the display as illustrated in FIG. 7A. In the Maps dialog 710, the user selects “Gradient”, and enters values for the minimum and maximum amounts, the gradient direction and step size as illustrated in FIG. 7B. The selected gradient is illustrated as plot 720. Design program 130 updates the Library View 730 to reflect the assignment of MonomerA to the selected library elements, as illustrated in FIG. 7C, and displays the map (“Add 0 to 100 μl MonomerA as a linear gradient (left to right, step 1) to New Library (B1: M12)) in Recipe View 740. Following the same procedure, the user defines corresponding gradients for monomers B (extending right to left) and C (extending bottom to top) as reflected in Recipe View 910 in FIG. 9B.

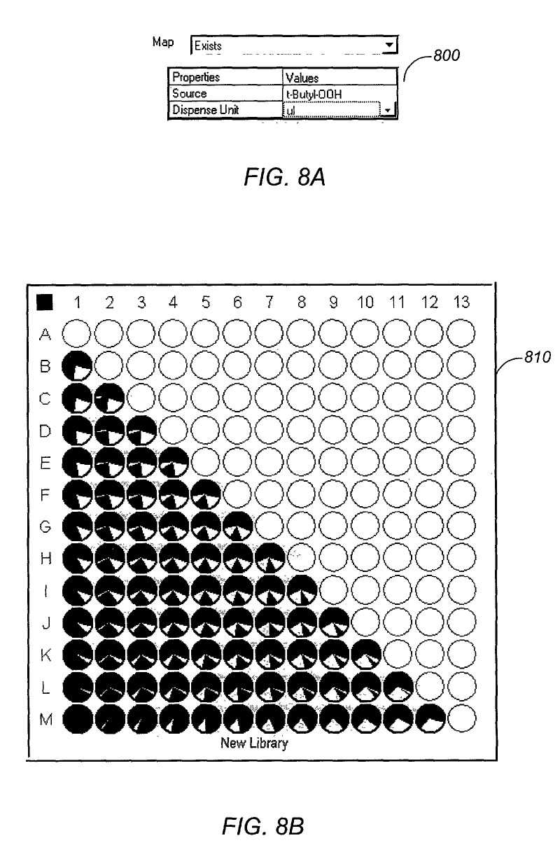

The user then maps the initiator and solvent to the same set of library elements. First, the user selects the initiator in the source pane and selects library elements B1 to M12. Referring to FIG. 8A, the user selects “Exists” in Maps dialog 800, and identifies the appropriate units. Design program 130 creates a corresponding equation group (Add ? μl t-Butyl-OOH to New Library (B1: M12) in Recipe View 910). Next, the user selects the solvent from the source pane and again selects the desired elements. The user selects “Exists” in the appropriate Maps dialog, again identifying the appropriate units. In response, design program 130 creates an equation group to define the solvent amounts for the selected library elements (“Add ? μl Solvent_{—}1 to New Library (B1: M12)” in Recipe View 910).

To define the amount of initiator, the user selects “Define Equation Map” from the appropriate toolbar or menu. In the Define Equation Map dialog, as described above, the user selects “t-Butyl-OOH” from the appropriate dropdown list, types the equals sign (“=”) and sets the amount to 10 μl to indicate that 10 μl of initiator will be dispensed into each library element. This causes design program 130 to display the corresponding equation (“t-Butyl-OOH”=10; μl; New Library (B1: M12)) in Recipe View 910.

To define the solvent amounts, in the Define Equation Map dialog the user selects TotalVolume, setting the amount to 200 μl. As a result, an amount of solvent is assigned to each library element sufficient to cause the total volume of sources assigned to that element (i.e., MonomerA+MonomerB+MonomerC+t-Butyl-OOH+Solvent_{—}1) to equal 200 μl. After the user selects OK, the formula (TotalVolume=200; μl; New Library (B1: M12)) is displayed in the Recipe View, and the Library View is updated to reflect the assignment of solvent to the selected library elements, as illustrated by Library View 810 shown in FIG. 8B.

The user then defines a duplicate set of experiments assigned to library elements A2 to L13 using analogous procedures. The results are illustrated in FIGS. 9A-B, which show the final library design in Library View 900, and the mapping sequence in Recipe View 910.

The invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical user interface through which computer programs interact with users. In a preferred implementation, the graphical user interface can include a “Design Wizard” providing a series of help dialogs for assisting users in the performance of the functions of the invention.

A number of implementations of the invention have been described. Nevertheless, it will be understood that various modifications may be made without departing from the spirit and scope of the invention. Accordingly, other embodiments are within the scope of the following claims.

What is claimed is:

1. A computer-implemented method for generating a library design for a set of experiments, comprising:
defining a library array representing an arrangement of experiments in the set of experiments, the library array including electronic data defining a plurality of elements, each of the plurality of elements representing a potential location for an experiment in the set of experiments;
defining a plurality of sources, each of the plurality of sources including electronic data representing a material or condition that can be used in the set of experiments;
receiving user input defining a plurality of maps representing the application of sources to elements of the library array, each of the plurality of maps including electronic data identifying one or more library elements and defining an amount of a corresponding source to be applied to the identified library elements, the plurality of maps being ordered to define a mapping sequence; and
generating a library design including electronic data representing the library array, the sources, the maps and the mapping sequence, the library design specifying for each of a plurality of library elements amounts of one or more sources to be applied to the corresponding library element, the amounts being defined at least in part by the order of maps in the mapping sequence.

2. The method of claim 1, further comprising:
displaying a visual representation of a plurality of experiments in the set of experiments.

3. The method of claim 2, wherein:
the visual representation includes a representation of at least a portion of composition including the specified amounts for a plurality of library elements corresponding to the plurality of experiments.

4. The method of claim 2, wherein:
the visual representation includes a representation of the mapping sequence, the maps in the mapping sequence being selectable in the visual representation.

5. The method of claim 4, wherein:
the visual representation includes a representation of a portion of a composition including the specified amounts for a plurality of library elements, the portion being determined based on a set of maps selected by the user.

6. The method of claim 1, wherein:
one or more of the maps in the mapping sequence has an associated equation defining a mathematical relationship for determining the amount of the corresponding source to be applied to the identified library elements based on an amount defined by a prior map in the mapping sequence.

7. The method of claim 6, wherein:
the mapping sequence includes a first group of maps, the first group of maps having a first set of associated equations defining a plurality of mathematical relationships for determining the amount of one or more sources to be applied to one or more identified library elements, the first set of associated equations being solvable as a set of simultaneous equations.

8. The method of claim 7, wherein:
the mapping sequence includes a second group of maps, the second group of maps having a second set of associated equations defining a plurality of mathematical relationships for determining the amount of one or more sources to be applied to one or more identified library elements, the first set of associated equations and second set of associated equations being separately solvable as sets of simultaneous equations.

9. The method of claim 1, wherein:
the plurality of maps includes a remove map defining an amount of a source to be removed from the identified library elements.

10. The method of claim 1, wherein:
one or more of the sources have type information representing a role played by the source in a chemical reaction and equivalence information quantifying behavior relating to the role; and
one or more of the maps define amounts for the one or more sources based in part on the equivalence information.

11. A computer program product on a computer-readable medium for generating a library design for a set of experiments, comprising instructions operable to cause a programmable processor to:
define a library array representing an arrangement of experiments in the set of experiments, the library array including electronic data defining a plurality of elements, each of the plurality of elements representing a potential location for an experiment in the set of experiments;
define a plurality of sources, each of the plurality of sources including electronic data representing a material or condition that can be used in the set of experiments;
receive user input defining a plurality of maps representing the application of sources to elements of the library array, each of the plurality of maps including electronic data identifying one or more library elements and defining an amount of a corresponding source to be applied to the identified library elements, the plurality of maps being ordered to define a mapping sequence; and
generate a library design including electronic data representing the library array, the sources, the maps and the mapping sequence, the library design specifying for each of a plurality of library elements amounts of one or more sources to be applied to the corresponding library element, the amounts being defined at least in part by the order of maps in the mapping sequence.

12. The computer program product of claim 11, further comprising instructions operable to cause a programmable processor to:
display a visual representation of a plurality of experiments in the set of experiments.

13. The computer program product of claim 12, wherein:
the visual representation includes a representation of at least a portion of a composition including the specified amounts for a plurality of library elements corresponding to the plurality of experiments.

14. The computer program product of claim 12, wherein:
the visual representation includes a representation of the mapping sequence, the maps in the mapping sequence being selectable in the visual representation.

15. The computer program product of claim 14, wherein:
the visual representation includes a representation of a portion of a composition including the specified amounts for a plurality of library elements, the portion being determined based on a set of maps selected by the user.

16. The computer program product of claim 11, wherein:
one or more of the maps in the mapping sequence has an associated equation defining a mathematical relationship for determining the amount of the corresponding source to be applied to the identified library elements based on an amount defined by a prior map in the mapping sequence.

17. The computer program product of claim 16, wherein:
the mapping sequence includes a first group of maps, the first group of maps having a first set of associated equations defining a plurality of mathematical relationships for determining the amount of one or more sources to be applied to one or more identified library elements, the first set of associated equations being solvable as a set of simultaneous equations.

18. The computer program product of claim 17, wherein:
the mapping sequence includes a second group of maps, the second group of maps having a second set of associated equations defining a plurality of mathematical relationships for determining the amount of one or more sources to be applied to one or more identified library elements, the first set of associated equations and second set of associated equations being separately solvable as sets of simultaneous equations.

19. The computer program product of claim 11, wherein:
the plurality of maps includes a remove map defining an amount of a source to be removed from the identified library elements.

20. The computer program product of claim 11, wherein:
one or more of the sources have type information representing a role played by the source in a chemical reaction and equivalence information quantifying behavior relating to the role; and
one or more of the maps define amounts for the one or more sources based in part on the equivalence information.

21. The method of claim 1, wherein:
one or more sources of the plurality of sources include electronic data representing a mixture of chemicals to be used in the set of experiments, the one or more sources including type information representing the one or more sources as including one or more chemicals in the mixture of chemicals and equivalence information representing an amount of the one or more chemicals included in the mixture of chemicals; and
the library design specifies amounts of the one or more chemicals in the mixture of chemicals to be applied to one or more of the library elements, the specified amounts being determined based on the type information and the equivalence information for the one or more sources.

22. The computer program product of claim 11, wherein:
one or more sources of the plurality of sources include electronic data representing a mixture of chemicals to be used in the set of experiments, the one or more sources including type information representing the one or more sources as including one or more chemicals in the mixture of chemicals and equivalence information representing an amount of the one or more chemicals included in the mixture of chemicals; and
the library design specifies amounts of the one or more chemicals in the mixture of chemicals to be applied to one or more of the library elements, the specified amounts being determined based on the type information and the equivalence information for the one or more sources.
